(19) United States
(12) Patent Application Publication
(10) Pub. No.: US 2008/0264522 A1
(43) Pub. Date: Oct. 30, 2008

(54) MAGNETIC STONE DEVICE AND METHOD OF MANUFACTURING THE SAME, AND MAGNETIC BEADS AND METHOD OF MANUFACTURING THE SAME

(76) Inventor: W. Frederick Conway, New Albany, IN (US)

Correspondence Address: BERENATO, WHITE & STAVISH, LLC, 6550 ROCK SPRING DRIVE, SUITE 240, BETHESDA, MD, 20817, US

(21) Appl. No.: 12/109,680

(22) Filed: Apr. 25, 2008

Related U.S. Application Data
(60) Provisional application No. 60/988,548, filed on Nov. 16, 2007.
(60) Provisional application No. 60/924,047, filed on Apr. 27, 2007.

(51) Int. Cl. H01F 1/00; A63H 33/04; A44C 17/02

(52) U.S. Cl. 148/101; 148/300; 446/92; 63/29.2

(57) ABSTRACT

A magnetic stone device and assembly is provided. The magnetic stone device includes a magnetic stone and a metallic coating applied to at least part of the surface of the magnetic stone. The coating has a first color at a first portion of the magnetic stone and a second color different from said first color at a second portion of the magnetic stone. A method of manufacturing the magnetic stone device is also provided. A magnetic bead, assembly, and method of manufacture are also provided.

### CROSS REFERENCE(S) TO RELATED APPLICATION(S) AND CLAIM(S) TO PRIORITY

The present invention claims priority from Provisional Patent Application Nos. 60/988,548 filed on Nov. 16, 2007 and 60/924,047 filed on Apr. 27, 2007, the contents of which are incorporated by reference herein.

### FIELD OF THE INVENTION

The present invention relates to a magnetic stone device and a method of manufacturing the same. The present invention also relates to magnetic beads and a method of manufacturing the same.

### BACKGROUND OF THE INVENTION

Magnets shaped as alphanumeric characters have been used by children to learn how to count and spell. These magnets typically have a colored plastic casing on one side thereof. However, these magnets are not attracted to each other and are limited to application on a magnetic surface having an opposite polarity, such as a magnetic board or refrigerator.

So called “rubber magnets” attract each other and are magnetized on a surface with one row as the north pole and the row next to it is the south pole, and alternate on the whole sheet.

Small dipole magnets are also known. For example, flat, circular magnets have been used for years. These small magnets have magnetic fields that attract each other to form a stacked configuration. However, these circular magnets typically have a dull black or grayish color making them aesthetically unappealing.

In an effort to make small magnets interesting or aesthetically appealing, pebble-shaped magnets have been manufactured. However, these small magnets suffer from similar drawbacks as the small circular magnets in that their color is dull and aesthetically unappealing. Additionally, these pebbles are made from magnetic materials that are typically very brittle and crack easily.

Accordingly, the present invention is intended to address the problem of providing a small dipole magnet which is aesthetically appealing and will not crack easily.

Additionally, small magnets have caused recent concerns about children swallowing or choking on these magnets. If a single magnet is swallowed, the magnet passes through without harming the child, because magnets are typically made non-toxic. A problem arises if two different magnets are swallowed at different times causing the two magnets to apply a magnetic force across intestinal walls. This interaction across intestinal walls can cause infection, permeation of the intestinal walls, and possibly death. In this case, the magnets do not simply pass through. Instead, the swallowed magnets must be surgically removed from the intestines. Accordingly, there is also a need for magnets that do not pose a choking or swallowing hazard to small children.

### SUMMARY OF THE INVENTION

The present invention is a decoratively colored magnetic stone. The magnetic stone has a metallic coating applied to at least part of the surface of the magnetic stone. The coating has a first color at a first portion of the magnetic stone and a second color different from the first color at a second portion of the magnetic stone. The coating is iridescent.

The present invention also provides a magnetic stone device having a magnetic body with an amorphous shape. The magnetic body has at least one dimension that is greater than or equal to 55 mm in at least one direction. A metallic iridescent coating with a varying thickness is applied to at least part of the surface of the magnetic stone. The coating is a first color at a first portion of the magnetic stone and a second color different from said first color at a second portion of the magnetic stone.

The present invention also provides a method of manufacturing a magnetic stone device. The method includes providing a magnetic stone having an amorphous shape, positioning the magnetic stone in a coating chamber, and depositing a metallic coating onto the magnetic stone in the coating chamber.

The present invention also provides a method of manufacturing a magnetic stone device. The method includes providing a stone having an amorphous shape, positioning the stone in a coating chamber, depositing a metallic coating onto the stone in the coating chamber, and magnetizing the stone along a predetermined axis.

The present invention also provides a decoratively colored magnetic bead device. The magnetic bead device includes a magnetic bead and a metallic coating applied to at least part of the surface of the magnetic bead. The coating is a first color at a first portion of the magnetic bead and a second color different from the first color at a second portion of the magnetic bead.

The present invention also provides a method of manufacturing a magnetic bead. A magnetic bead is provided. Then, the magnetic bead is positioned in a coating chamber. A metallic coating is deposited onto the magnetic bead in the coating chamber.

### BRIEF DESCRIPTION OF THE DRAWINGS

FIG. 1A is a plan view of a magnetic stone device according to an embodiment of the present invention;

FIG. 1B is a side cross-sectional view of the magnetic stone device of FIG. 1A taken along line A-A;

FIG. 2A is a plan view of a magnetic stone device according to another embodiment of the present invention;

FIG. 2B is a side cross-sectional view of the magnetic stone device of FIG. 2A taken along line B-B;

FIG. 3 is a side view of a magnetic stone device assembly according to another embodiment of the present invention;

FIG. 4 is a flowchart diagram illustrating a method of manufacturing a magnetic stone device according to an embodiment of the present invention;

FIG. 5 illustrates a flowchart diagram illustrating a method of manufacturing a magnetic stone device according to another embodiment of the present invention;

FIG. 6 is a fragmentary plan view illustrating magnetic stone devices being supported on a support net during the method of FIG. 5, according to another embodiment of the present invention;

FIGS. 7A and 7B illustrate side views of a plurality of stones arranged along a thread during the method of FIG. 5, according to different embodiments of the present invention;

FIGS. 8A and 8B illustrate coating chambers used in the method of FIG. 5, according to different embodiments of the present invention;

FIG. 9A is a perspective view of a magnetic bead according to yet another embodiment of the present invention;

FIG. 9B is a side cross-sectional view of the magnetic bead of FIG. 9A taken along line C-C;

FIG. 10 is an elevational side view of a stacked arrangement of magnetic beads according to another embodiment of the present invention;

FIG. 11 is a flowchart diagram illustrating a method of manufacturing magnetic beads according to another embodiment of the present invention;

FIG. 12 is a flowchart diagram illustrating a method of manufacturing magnetic beads according to another embodiment of the present invention;

FIGS. 13A and 13B illustrate side views of a plurality of magnetic beads arranged along a thread during the method of FIG. 12, according to different embodiments of the present invention;

FIG. 14 is a top plan view of a jewelry item having the magnetic beads of FIGS. 9A and 9B, according to yet another embodiment of the present invention;

FIG. 15 is a perspective view of a choke tube having a magnetic stone according to an embodiment of the present invention; and

FIGS. 16A and 16B are side elevational views of magnetic stones according to different embodiments of the present invention.

### DESCRIPTION OF THE EMBODIMENTS OF TH INVENTION

Reference will now be made in detail to the embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

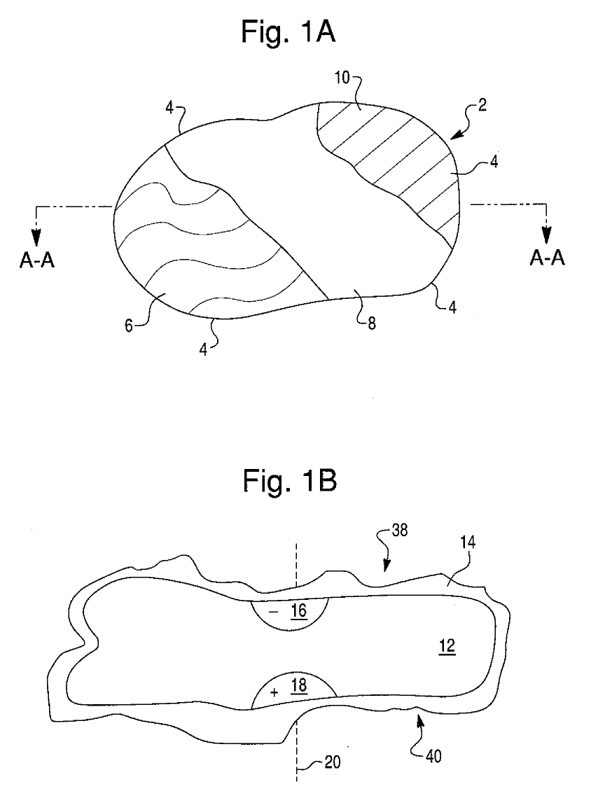

As best shown in FIG. 1A, a magnetic stone device 2 has an amorphous shape defined by several rounded edges 4. The stone device 2 includes regions 6, 8, and 10 of different colors and/or characteristics.

As best shown in FIG. 1B, the stone device 2 includes a stone 12 and a coating 14 applied around the surface of the stone 12. The coating 14 has a varying thickness and covers substantially all the surface of the stone 12. The stone 12 may be a ceramic material, such as a ferrite material.

The coating 14 is an iridescent coating that appears to be different colors due to its varying thickness. As best shown in FIG. 1A, the first region 6 has a first color denoted by curved lines, the second region 8 has a second color denoted by blank space, and the third region 10 has a third color denoted by straight lines. It will be appreciated that a greater or lesser number of regions and/or colors may be disposed on the magnetic stone device 2. The various colors on the magnetic stone device 2 are a result of the iridescent coating 14 on the surface of the stone 12 shown in FIG. 1B. The coating 14 provides an appearance that is more aesthetically appealing than the dull grayish/black color that is characteristic of conventional magnets.

The iridescent coating 14 is a metallic or dielectric coating having a thickness which varies along the surface of the stone 12. For example, the coating 14 may be titanium. The coating 14 may have a thickness that is on the order of 0.00005 inches, a thickness found to provide added strength and durability to the stone 12 without requiring excess coating material. Because ceramic/ferrite magnets are typically brittle and crack easily, the titanium coating 14 also provides a protective covering to the stone 12. Thus, even when the magnetic stone device 2 impacts another magnetic stone or a hard surface, the titanium coating 14 can prevent cracking of the stone 12.

As best shown in FIG. 1B, the magnetic stone device 2 is a dipole magnet with an anisotropic magnetic field having a first pole 16 and a second pole 18 of opposite polarity. Ceramic grades 5 or 8, which produce a strong anisotropic magnetic field, may be used as the material for forming the stone 12. A magnetic axis 20 of the magnetic stone device 2 is defined along where the two poles 16 and 18 of the stone device 2 are located. Alternatively, the magnetic field may be isotropic.

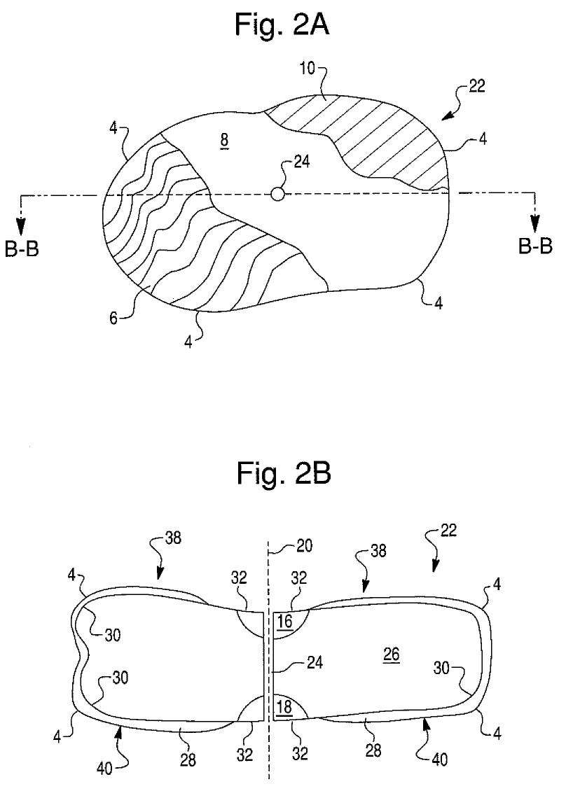

FIGS. 2A and 2B illustrate a magnetic stone device 22 according to another embodiment of the present invention. Here, the magnetic stone device 22 has the same rounded edges 4, regions 6, 8, and 10, magnetic axis 20, and poles 16 and 18. The stone device 22 further includes a hole 24 extending therethrough, the purpose of which will become clear from the description of the method below.

As best shown in FIG. 2B, the stone device 22 includes a stone 26 and a coating 28 applied around a majority of the surface of the stone 26. The stone device 22 shown in FIG. 2B has a coated portion 30 and an uncoated portion 32. The uncoated portion 32 is disposed around the area where the hole 24 extends through the stone 26. In the present embodiment, the coated portion 30 may comprise about 3% of the entire surface area of the stone 26. The reason for the coated and uncoated portions 30 and 32, respectively, will also become apparent from the description of the method that follows.

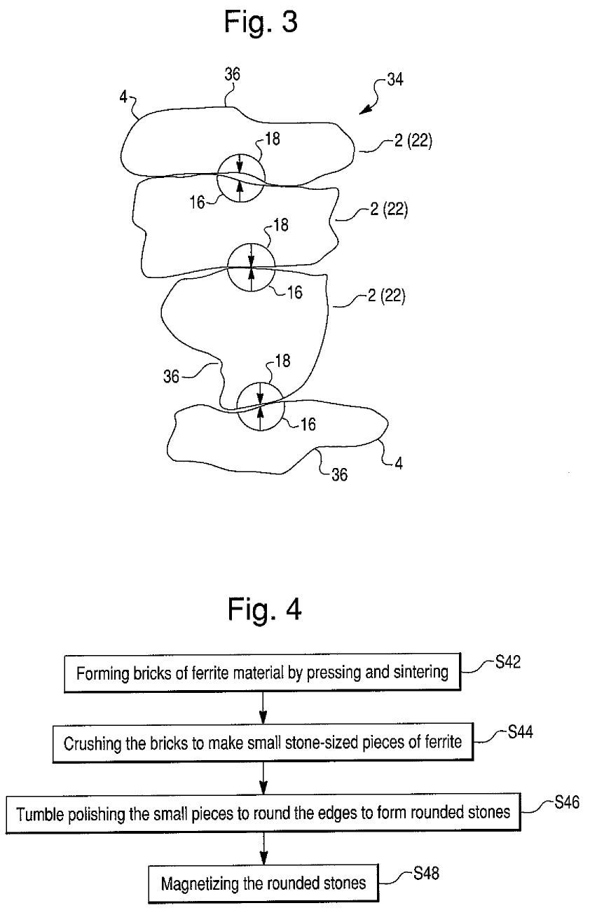

As best shown in FIG. 3, a magnetic stone assembly 34 includes a plurality of magnetic stone devices 2 (22) similar to the magnetic stone device 2 shown in FIGS. 1A and 1B or the magnetic stone device 22 shown in FIGS. 2A and 2B. Each of the magnetic stone devices 2 (22) has first and second poles 16 and 18 of opposite polarity. The first and second poles 16 and 18 of opposite polarity attract each other so as to form the stacked arrangement shown in FIG. 3.

The stone assembly 34 is pocket sized and can be manipulated by young children. Additionally, the stone devices 2 (22) may be formed substantially hexahedral-shaped or box-shaped with the rounded edges 4 and surface irregularities 36. The surface irregularities 36, as best shown in FIG. 3, are randomly positioned indentations or bumps in the surface of the stone devices 2 (22). The shapes of the stone devices 2 (22) make them easily stacked on top of one another.

Referring back to FIGS. 1B and 2B, the stone devices 2 and 22 may have first and second major surfaces 38 and 40 (denoted by arrows) that have a greater size than the other surfaces of the stone device 2 (22). In some stone devices 2 (22), the major surfaces 38 and 40 may be substantially parallel to one another. Due to the orientation of the magnetic field of the stone devices 2 (22), these first and second surfaces 38 and 40 correspond to the first and second poles 16 and 18, respectively. As a result, the first and second major surfaces 38 and 40 of neighboring magnetic stone devices 2 (22) contact each other.

The stones 12 and 26 best shown in FIGS. 1B and 2B, respectively, may be formed using the method of FIG. 4. In step S42, a brick of ferrite ceramic material is formed by mixing iron ore powder with a resin, pressing and sintering the mixture, and baking the mixture in an oven. More specifically, in step S42, metal powder including iron ore, strontium, and a glue bonding material are pressed together into a brick shape. A magnetic field may be applied during step S42. Here, the magnetic field is used to align the electrons in the same direction when the brick is being formed. That is, the molecules of the magnetic material that would otherwise have north and south poles pointing in different directions are all aligned due to the applied magnetic field. As a result, all the north and south poles of the individual molecules are aligned together. Ultimately, this alignment process makes the magnet stronger. However, in embodiments where a strong magnet is not desired, the alignment process may be omitted. For example, when a larger “choke proof” magnet is manufactured, the size of the magnet alone creates a magnetic force that is sufficiently strong to hold magnets together. Thus, in order to avoid creating magnets that are too strong and could smash a user's fingers, the alignment process is omitted.

Then the brick is positioned in a furnace to make a solid ceramic piece, at about 130° C. The brick may lose the magnetic field at this temperature. After removal from the furnace, the brick can be shaped into any form such as stones or beads by crushing and tumbling. Thus, in step S44, the ferrite brick is crushed into small stone-sized chunks of ferrite. As described below, the small stone-sized chunks can be sized large enough so as not to be swallowed by children.

At this point, the chunks of ferrite have some jagged edges and are irregularly shaped. At step S46, the chunks of ferrite are tumble polished in large drums that round the edges and polish the surface to create a semi-reflective finish. To this end, the drum may have various stages of grit for polishing the surface of the chunks of ferrite. This step may take an extended period of time, for example 4-6 days, in order to obtain stones of the desired shape. The desired shape has rounded edges 4 and/or surface irregularities 36 having substantially no jagged edges, as best shown in FIG. 3.

Although not shown in FIG. 4, the chunks of ferrite material may be further polished in one or more additional polishing steps. For example, the chunks of ferrite material may be polished in a shaker.

Finally, in step S48, the stones obtained from the polishing step S46 are magnetized. In this step, a large magnetic field may be applied to the stones to align electrons within the stones such that the stones retain a magnetic field. During magnetization, the stones are oriented so that the magnetic field is created therein along a predetermined direction forming the first and second poles 16 and 18 therein. Accordingly, stones 12 (26) are manufactured.

In alternative embodiments of the present invention, the stones 12 (26) obtained from the polishing step S46 may be magnetized randomly instead of along a predetermined direction. In this case, the expense of orienting the stones in a particular position becomes unnecessary. Additionally, random magnetization may be used for large magnets that would otherwise create too strong of a magnetic field if magnetized along a single direction.

A step for applying the coating 14 (28) to the stone 12 (26) may be performed before or after the magnetization step S48.

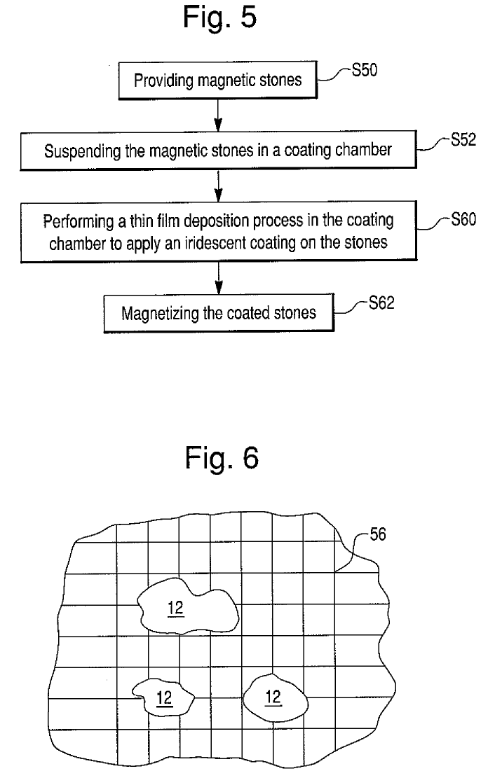

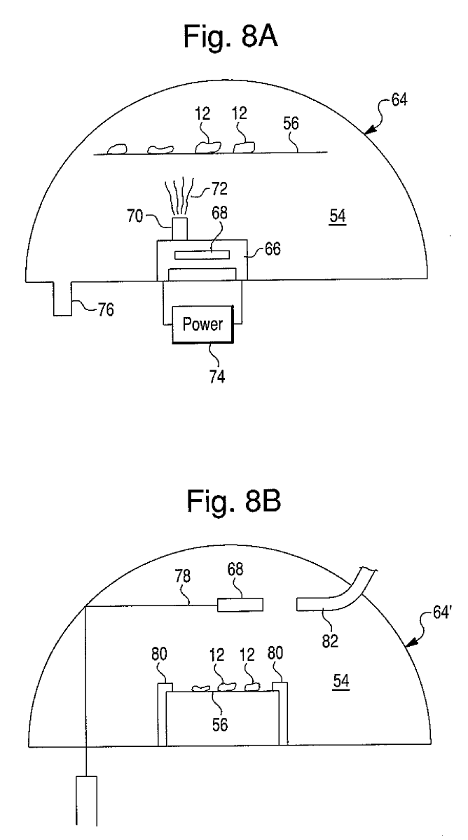

As best shown in FIG. 5, a method of manufacturing magnetic stone devices 2 (22) according to another embodiment of the present invention includes providing stones 12 (26) in step S50. Step S50 may include steps S42 through S48 of the method of FIG. 4 for providing magnetized stones 12 (26). In step S52, the stones 12 (26) are suspended in a coating chamber 54 as best shown in FIGS. 8A and 8B.

More particularly, in step S52, the stones 12 may be arranged on a support net 56 in the coating chamber 54 as best shown in FIG. 6. The net 56 may be a 16 gauge metal mesh having holes that are slightly smaller than the size of the stones 12. The stones 12 are preferably coated two or more times, repositioning the stones 12 each time to avoid leaving uncoated lines on the surface of the stones 12 due to contact with the mesh. In this case, the stones 12 can be positioned on the first major surface 38 for a first coating operation and positioned on the second major surface 40 for a second coating operation. Accordingly, each side of the stones 12 is completely exposed during at least one of the coating operations.

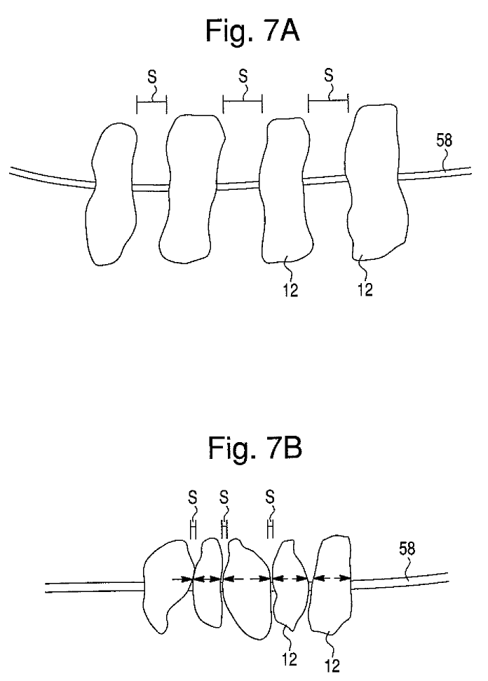

Alternatively, in step S52, the elongated holes 24 can be drilled through the stones 26 as shown in FIGS. 2A and 2B so that a thread 58 is arranged through the elongated holes 24 in the stones 26, as best shown in FIGS. 7A and 7B. “Thread” as used herein refers to a wire, a string, a cable, or any other thin elongated, typically flexible, member that is capable of supporting the stones 26 via their respective holes 24. In this manner, the stones 26 can be suspended in the coating chamber 54. In step S52, if the stones 26 are not magnetized first, the stones 26 can be spaced apart from each other by a spacing “S” so that a majority of the surface of the stones 26 is exposed, as best shown in FIG. 7A. On the other hand, if the stones 26 are magnetized first, the spacing “S” can be minimized due to the magnetic attraction force between neighboring stones 26, as best shown in FIG. 7B. In this case, although portions of the surface of the stones 26 are not exposed, the number of stones 26 arranged on the thread 58 can be increased. In this manner, the number of stones 26 being processed at one time using the method of FIG. 5 can be increased. Alternatively, seed beads, such as seed beads 141 shown in FIG. 13B, may be used to maintain appropriate spacing between adjacent stones 26 that would otherwise contact each other due to magnetic force.

Referring back to FIG. 5, in step S60, a thin film deposition process is performed to deposit the coating 14 (28) on the stones 12 (26) to produce the stone device 2 (22) shown in FIGS. 1A to 1B and 2A to 2B. Finally, the stones 12 (26) are magnetized in step S62.

Referring back to step S60, FIGS. 8A and 8B show two different exemplary thin film deposition processes. As best shown in FIG. 8A, a physical vapor deposition (PVD) apparatus 64 performs an evaporation process to deposit the coating 14 best shown in FIG. 1B on the stones 12. The PVD apparatus 64 includes the coating chamber 54 which is a vacuum chamber during operation.

The PVD apparatus 64 further includes a heating baffle 66 and a target substance 68 disposed in the heating baffle 66. The heating baffle 66 may have an output tube 70 through which vapor 72 from the target substance 68 is output toward the stones 12. The heating baffle 66 may be shaped like a box or a boat for supporting the target substance 68. The heating baffle 66 is made of electrically conductive and/or thermally conductive material to allow the temperature of the target substance 68 to be increased by applying power to the heating baffle 66.

A power supply 74 causes the heating baffle 66 to heat the target substance 68 sufficiently to evaporate and rise toward the stones 12, which are supported in the coating chamber 54 via the support net 56. The power supply 74 may either heat the baffle 66 or apply a voltage to the baffle 66 to cause the target substance 68 to evaporate.

A cool air inlet 76 provides cool air into the coating chamber 54 so that a temperature differential is created between where the heating baffle 66 is positioned and where the stones 12 are supported. As the vapor 72 rises toward the stones 12, the vapor 72 condenses onto the stones 12 forming a thin film of the target substance 68 around an outer surface of the stones 12.

As best shown in FIG. 8B, a physical vapor deposition (PVD) apparatus 64′ performs a sputtering process to deposit the coating 14 best shown in FIG. 1B on the stones 12. The PVD apparatus 64′ includes the coating chamber 54 which is a vacuum chamber during operation.

The PVD apparatus 64′ further includes a first terminal 78 having a first polarity, for example positive, and a second terminal 80 having a second polarity, for example negative. The target substance 68 is disposed at the first terminal 78. The stones 14 are supported by the support net 56 in the coating chamber 54 about the second terminal 80.

Plasma gas, for example argon, is input to the coating chamber 54 via plasma inlet 82. The plasma gas bombards the target substance 68 and directs atoms of the target substance 68 toward the stones 12 so that the atoms of the target substance 68 collect on the surface of the stones 12 thereby forming a thin film of the target substance 68 around the stones 12.

When the stones 12 are supported on the support net 56 as best shown in FIG. 6, two or more coating operations can be performed in the coating chamber 54 so as to prevent the mesh of the net 56 from leaving an uncoated lines on the surface of the stones 12. Accordingly, the entire surface of the stones 12 can be coated with the target substance 66.

It should be understood that other coating processes, such a electroplating, may be used to coat the stones 12 (26). Additionally, although FIGS. 8A and 8B show use of the support net 56 for suspending the stones 12 in the coating chamber 54, it will be appreciated that the stones (12) 26 may alternatively be suspended in the coating chamber 54 using the thread 58 shown in FIGS. 7A and 7B.

The target substance 68 is preferably titanium (Ti). The titanium atoms are deposited on the stones 12 (26) to form the coating 14 (28). It will be appreciated that other metallic and/or dielectric materials having similar properties to titanium may be used to form the coating 14 (28).

The thin film of titanium, which forms the coating 14 (28) shown in FIGS. 1A to 2B, has a thickness which varies around the surface of the stones 12 (26) so as to form the iridescent coating 14 (28). This varying thickness can be achieved by virtue of the irregular/amorphous shapes of the stones 12 (26) and the positioning of the stones 12 (26) when suspended in the coating chamber 54. Moreover, the inherent randomness of the thin film deposition process also contributes to this varying thickness.

Additionally, the evaporation process of FIG. 8A and the sputtering process of FIG. 8B can be controlled to vary the thickness of the titanium film deposited on the stones 12 (26). In particular, the amount of power provided to the heating baffle 66 by the power supply 74 can be adjusted to control the evaporation rate of the titanium target substance 68. In turn, the thickness of the titanium being deposited on the stones 12 (26) is also adjusted. Similarly, the flow rate of plasma gas introduced to the coating chamber 54 via the plasma inlet 82 can be adjusted to control the atomization of the titanium so as to affect the thickness of the titanium film being deposited on the stones 12 (26). Additionally, the amount of time that the stones 12 (26) are processed also determines the thickness of the coating 14 (28). Other process parameters can also be manipulated to vary the thickness of the titanium film deposited on the stones 12 (26).

The coating 14 (28) may be formed to have a thickness that is on the order of 0.00005 inches, a thickness found to provide added strength and durability to the stone 12 (26) without requiring excess coating material.

It will be appreciated by one of ordinary skill in the art that certain components of the PVD apparatus 64 and 64′ of FIGS. 8A and 8B have been omitted for illustration purposes.

It will also be appreciated that other thin film deposition processes may be used to apply the coating 14 (28) to the stones 12 (26). For example, a chemical vapor deposition (CVD) can alternatively be used to form the coating 14 (28) on the stones 12 (26).

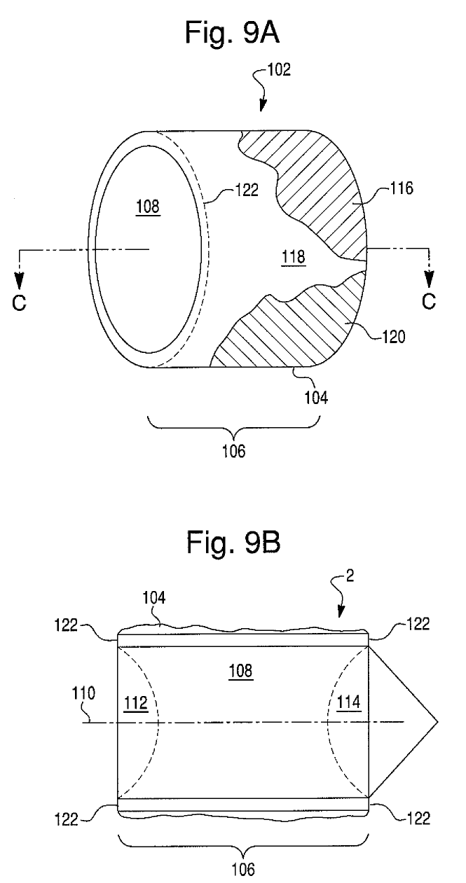

In another embodiment of the present invention best shown in FIGS. 9A and 9B, a magnetic bead 102 includes an iridescent coating 104 surrounding an outer cylindrical surface thereof. The magnetic bead 102 may be a jewelry bead that can be used to make bracelets, necklaces, or the like.

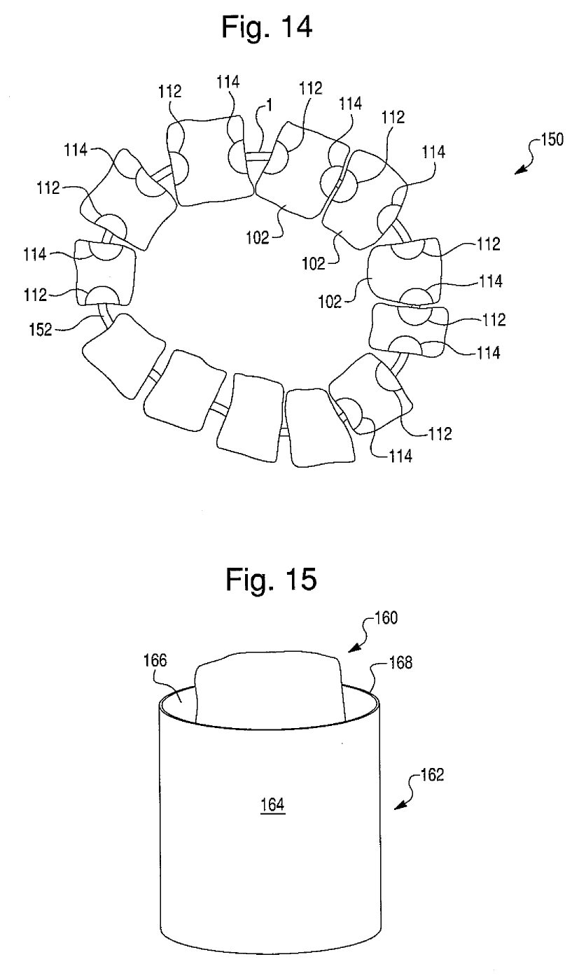

It should be understood that the shape and size of the bead 102 shown in FIGS. 9A and 9B is intended to be exemplary as beads of other shapes and sizes may alternatively be used with the present invention. The bead 102 includes an elongated cylindrical portion 106 on which the coating 104 is formed. The bead 102 includes a through hole 108 defined by the cylindrical portion 106. A magnetic axis 110 denoted by a dashed line in FIG. 9B extends along a central axis of the through hole 108 so that the attractive magnetic force between two beads 102 forces the neighboring through holes 108 into alignment. Accordingly, neighboring magnetic beads 102 may be used to make jewelry by stringing several magnetic beads 102 together via the through holes 108, as best shown in FIG. 14.

First and second magnetic poles 112 and 114 of opposite polarity denoted by dashed line semi-circles in FIG. 9B are disposed on opposite sides of the magnetic bead 102. In an alternative embodiment, the beads 102 may be randomly magnetized. In this case, less time and effort is required to align the beads 102 before magnetizing.

As best shown in FIG. 9A, the coating 104 of the magnetic bead 102 varies in thickness so that first, second, and third regions 116, 118, and 120 of different colors and/or visual characteristics are formed. Due to the varying thickness of the iridescent coating 104, the magnetic bead 102 is provided with an appearance that is aesthetically appealing.

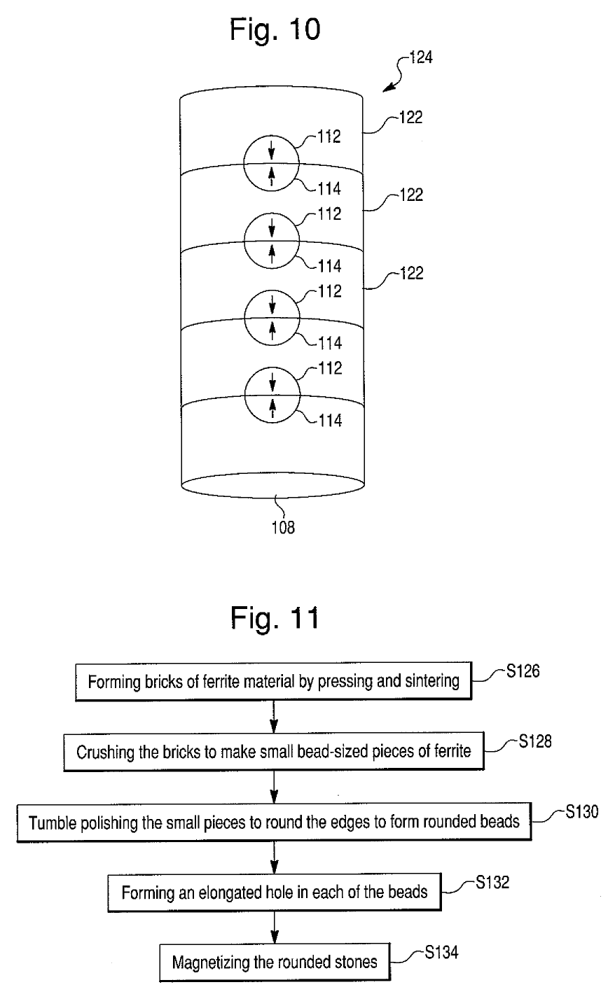

The magnetic bead 102 may include uncoated portions 122 on opposite ends of the cylindrical portion 106, which may result from the manufacture of the beads. As best shown in FIG. 10, a stacked arrangement 124 of the magnetic beads 102 aligns the magnetic axes 110 of each of the beads 102. Thus, the stacked arrangement of beads 124 is easily disposed in a pocket or made into jewelry.

As best shown in FIG. 11, a method of manufacturing a magnetic bead 102 is similar to the method of manufacturing a magnetic stone device of FIG. 4. In step S126, bricks of ferrite material are formed by pressing and sintering. In step S128, the bricks formed in S126 are crushed to make small bead-sized pieces of ferrite. As described below, the small bead-sized pieces can be sized large enough so as not to be swallowed by children. The bead-sized pieces of ferrite are then tumble polished to round the edges in S130. In step S132, an elongated hole is formed in each one of the pieces of ferrite to form the through holes 108 of the beads 102. Then, in step S134, the beads 102 are magnetized to form magnetic beads.

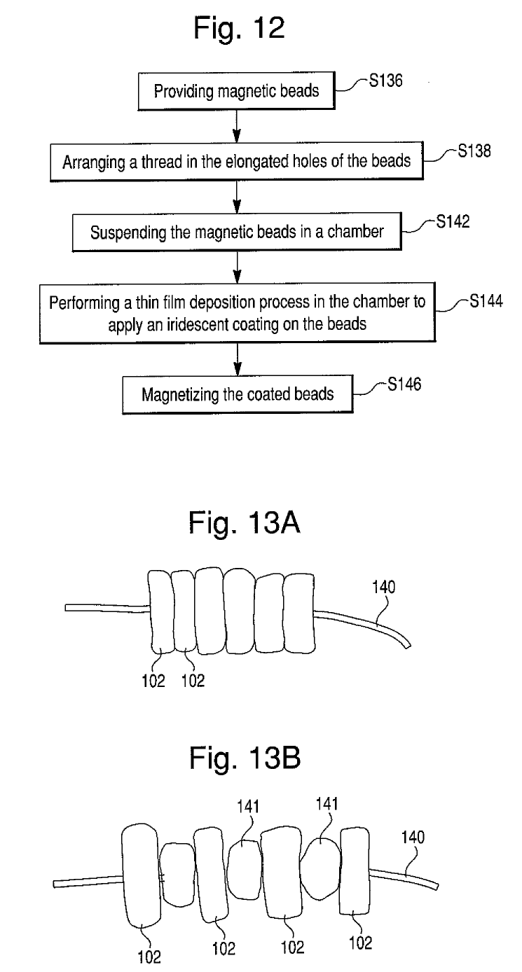

As best shown in FIG. 12, a method of manufacturing a magnetic bead 102 is similar to the method of manufacturing a magnetic stone device of FIG. 5. In step S136, beads 102 are provided. Step S136 may correspond to the method of FIG. 11. In step S138, a thread 140 may be arranged in the elongated through holes 108 of the beads 102. In step S142, the threaded beads 102 are suspended in a coating chamber, similar to the coating chamber 54 shown in FIGS. 6A and 6B. In step S144, a thin film deposition is performed to apply an iridescent coating on the beads 102. Then, in step S146, the beads 102 are magnetized again. The beads 102 may alternatively be suspended in the coating chamber 54 using a support net, such as the support net 56 shown in FIG. 6.

As best shown in FIGS. 13A and 13B, the beads 102 may be arranged on the thread 140 with minimal spacing, or with a larger spacing if seed beads 141 are arranged between the beads 102. As best shown in FIG. 13B, the seed beads 141 maintain appropriate spacing between the beads 102 such that the area coated on the beads 102 can be maximized, even when the beads 102 have a strong magnetic attraction. The seed beads 141 may be smaller in diameter than the magnetic beads 102 so as to contact a minimal portion of the magnetic beads 102. In this case, the uncoated portion 122 shown in FIGS. 9A and 9B may be minimal or nonexistent.

In the case shown in FIG. 13A, the magnetic beads 102 contact each other due to the magnetic force. As a result, the areas of contact are not exposed, and are therefore, not coated in the thin film deposition process. This leaves the uncoated portions 122 on both ends of the magnetic beads 102. However, due to the fact that the ends of the cylindrical portion 106 are small in comparison to the surface of the cylindrical portion 106, these uncoated portions 122 are barely noticeable.

It should be understood that some of the description of the magnetized beads 102 and the associated methods of manufacture has been omitted to the extent that it would be repetitive of the magnetic stone devices 2 (22) and the associated method of manufacture. However, it will be appreciated that the concepts described above with reference the magnetic stone devices 2 (22) can be applied to the magnetic beads 102 of the present embodiment.

As best shown in FIG. 14, a jewelry item 150 may be made using the magnetic beads 102 of the present embodiment of the invention. The jewelry item 150 may be, for example, a bracelet or the like. The beads 102 are arranged on a cord 152, which may be elastic. As can be seen from FIG. 14, the magnetic poles 112 and 114 of opposite polarity of neighboring beads 102 may be positioned next to each other such that the beads 102 are attracted to each other. Accordingly, a user can wear the jewelry item 150 while manipulating the magnetic beads 102.

As best shown in FIG. 15, a magnetic stone 160 is measured to determine whether children will be able to swallow or choke on the stone 160. “Children” is being used herein to refer to children who are under three years of age. A choke tube 162 is designed to indicate whether the stone is “choke proof.” The choke tube 162 is a container 164 having an open end 166 and a brim 168. Any object that does not fit entirely within the choke tube 162 such that a portion thereof extends above the brim 168 is determined not to pose a choke or swallowing hazard to children. Indeed, the choke tube 162 is preferably dimensioned such that any object that is 33 mm across or larger in all directions or 55 mm across or larger in at least one direction will not be contained entirely within the container 164. Thus, objects that are 33 mm across in all directions or 55 mm across in one direction have been determined to be choke proof.

To this end, the diameter of the open end 166 of the choke tube 162 is slightly less than 33 mm so that an object that is 33 mm in all directions cannot drop into the container 164. Similarly, the width and height of the choke tube 162 are dimensioned such that a slim object that is greater than or equal to 55 mm in length will extend above the brim 168 regardless of how the thin object is angled in the bottom of the container 164. The dimensions of the choke tube 162 have been selected, because objects that do not fit in the choke tube 162 have been found not to fit down a child's throat. Accordingly, the magnetic stone 160 is “choke proof,” and cannot be swallowed by a child.

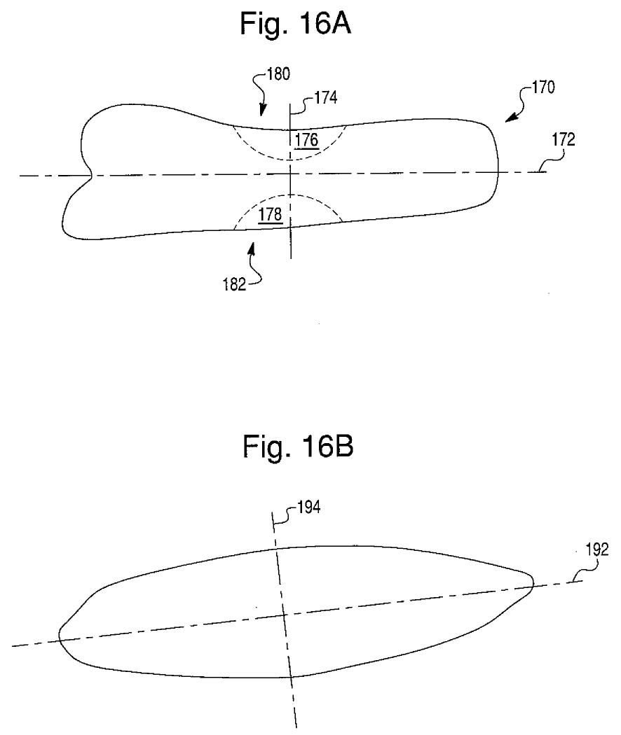

As best shown in FIG. 16A, a magnetic stone 170 having an amorphous shape, as described above, is dimensioned to be choke proof. The magnetic stone 170 includes a major axis 172 extending along the longest dimension of the stone 170 and a minor axis 174 extending along the shortest dimension of the stone 170. Poles 176 and 178 are disposed on opposite sides of the stone 170. The magnetic stone 170 is greater than or equal to 55 mm along the major axis 172, while the magnetic stone 170 is preferably slim along the minor axis direction 174.

The larger the magnetic stone 170, the larger the magnetic force is produced with respect to a neighboring stone. However, when the magnetic force is too large, neighboring magnetic stones may be difficult for a user to pull apart. In some cases, neighboring magnetic stones may even crush a user's fingers. Thus, minimizing the size of the magnetic stone 170 along at least one direction offsets the increase in magnetic field that results from making the magnetic stone 170 large enough to be “choke proof.” As a result, the magnetic stones 170 can be made “choke proof” without substantially increasing the magnetic force. The magnetic stone 170 can also be magnetized randomly instead of along a single direction to prevent a magnetic field from becoming overly strong. Random magnetization provides a weaker magnetic force than magnetization along a single direction. In this case, the electrons in the molecules of the magnetic material are not aligned in a single direction prior to formation of the magnets. Thus, north and south poles of each of the molecules are oriented in different directions so that magnetization directions of each individual molecule are different. Thus, when the magnetization directions of the molecules are not aligned in one direction, the magnetic force is not as strong.

Preferably, the dimension of the magnetic stone 170 along the minor axis 174 is less than half of the dimension of the stone 170 along the major axis 172. Additionally, two opposing major surfaces 180 and 182 of the magnetic stone 170 may be substantially flat so that one of the opposing major surfaces 180 and 182 stably engages one of the major opposing surfaces of a neighboring stone.

Although not shown, a depth dimension of the magnetic stone 170, i.e., the dimension extending perpendicular to the plane of FIG. 16A, may be between the length dimension along the major axis 172 and the width dimension along the minor axis 174.

As best shown in FIG. 16B, a magnetic stone 190 according to another embodiment of the present invention has a rounded ovular shape. Similar to the magnetic stone 170, shown in FIG. 16A, the magnetic stone 190 has a length along a major axis 192 that is substantially larger than a width along a minor axis 194.

It should be understood that other shapes and sizes may alternatively be used for magnetic stones described above. For example, the magnetic beads of FIG. 10 may be made according to the dimensions specified above.

Accordingly, embodiments of the present invention described above provide magnetic stones that are large enough that they cannot be swallowed by small children. Additionally, due to the magnetization and shape of these stones, the magnetic fields provided are not overly strong so that a user need not worry about the stones smashing his or her fingers or being difficult to separate.

The embodiments of the present invention described above also provide a magnetic stone device with a coating that protects the magnetic material from cracking and, at the same time, is more aesthetically appealing than the conventional dull gray color of magnets.

The embodiments of the present invention described above also provide a magnetic stone device assembly having a plurality of magnetic stone devices having amorphous shapes and two magnetic poles so that the magnetic stone devices are attracted to each other and naturally form a stacked configuration.

The embodiments of the present invention described above also provide a method for manufacturing magnetic stone devices and applying a single coating to the magnetic stone devices which is both protective and decorative.

The embodiments of the present invention described above also provide magnetic beads that are appealing and can be arranged as a stacked arrangement and/or a jewelry item.

Although embodiments of the present invention have been shown and described, it will be appreciated by those skilled in the art that changes may be made in these embodiments without departing from the principles and spirit of the invention, the scope of which is defined in the appended claims and their equivalents.

What I claim is:

1. A magnetic stone device, comprising:
a magnetic stone; and
a metallic coating applied to at least part of the surface of said magnetic stone,
wherein said coating is a first color at a first portion of said magnetic stone and a second color different from said first color at a second portion of said magnetic stone.

2. The magnetic stone device of claim 1, wherein said coating is iridescent.

3. The magnetic stone device of claim 1, wherein said coating comprises titanium.

4. The magnetic stone device of claim 1, wherein said coating has a thickness that varies on different parts of said magnetic stone.

5. The magnetic stone device of claim 1, wherein said magnetic stone has a magnetic field that is anisotropic.

6. The magnetic stone device of claim 1, wherein said coating has a thickness of about 0.00005 inches.

7. The magnetic stone device of claim 1, wherein said magnetic stone has a substantially hexahedral shape with rounded edges and surface irregularities disposed in the surface of said magnetic stone.

8. The magnetic stone device of claim 7, wherein said substantially hexahedral shape has first and second major surfaces on opposite sides of said magnetic stone, said first and second major surfaces being larger than the other surfaces of said magnetic stone and being arranged substantially parallel to one another.

9. The magnetic stone device of claim 1, wherein said at least one magnetic stone includes a plurality of magnetic stones, each of said magnetic stones having first poles and second poles that are attracted to each other so that the magnetic stones form a stacked arrangement.

10. The magnetic stone device of claim 1, wherein said at least one magnetic stone is greater than or equal to 55 mm in at least one direction.

11. The magnetic stone device of claim 1, wherein said at least one magnetic stone is greater than or equal to 33 mm in every direction.

12. The magnetic stone device of claim 1, wherein said at least one magnetic stone comprises a first dimension extending along a major axis thereof, and a second dimension extending along a minor axis thereof, the major axis and minor axis being perpendicular to each other, and the first dimension being at least twice as large as the second dimension.

13. The magnetic stone device of claim 1, wherein said at least one magnetic stone comprises a plurality metallic magnetic molecules, each of said magnetic molecules having a different magnetization direction.

14. A magnetic stone device, comprising:
a magnetic body having an amorphous shape, said magnetic body being greater than or equal to 55 mm in size along at least one direction; and
a metallic iridescent coating with a varying thickness applied to at least part of a surface of said magnetic stone,
wherein said coating is a first color at a first portion of said magnetic stone and a second color different from said first color at a second portion of said magnetic stone.

15. A method of manufacturing a magnetic stone device, the method comprising the steps of:
providing a magnetic stone having an amorphous shape;
positioning the magnetic stone in a coating chamber; and
depositing a metallic coating onto the magnetic stone in the coating chamber.

16. The method of claim 15, wherein the providing of the magnetic stone comprises:
forming bricks of ferrite material;
crushing the bricks of ferrite material into pieces that are greater than or equal to 55 mm in size along at least one direction; and
tumble polishing the pieces of ferrite to round jagged edges and to polish surfaces of the pieces.

17. The method of claim 16, wherein the forming of the bricks of material comprises pressing and sintering metallic powder in the absence of an external magnetic field.

18. The method of claim 15, wherein the providing of the magnetic stone comprises providing the magnetic stone having rounded edges with surface irregularities and substantially no jagged edges.

19. The method of claim 15, wherein the deposition of the coating comprises atomizing titanium onto an outer surface of the magnetic stone.

20. A method of manufacturing a magnetic stone device, the method comprising:
providing a stone having an amorphous shape;
positioning the stone in a coating chamber;
depositing a metallic coating onto the stone in the coating chamber; and
magnetizing the stone along a predetermined axis.

21. A magnetic bead device, said magnetic bead device comprising:
a magnetic bead; and
a metallic coating applied to at least part of the surface of said magnetic bead, wherein said coating is a first color at a first portion of said magnetic bead and a second color different from said first color at a second portion of said magnetic bead.

22. The magnetic bead device of claim 21, wherein said magnetic bead comprises an elongated cylindrical portion and a through hole extending therethrough.

23. The magnetic bead device of claim 22, wherein said magnetic bead comprises a plurality of magnetic beads arranged on a cord as a jewelry item.

24. The magnetic bead device of claim 21, wherein said magnetic bead comprises a plurality of magnetic beads with respective coatings, each of said magnetic beads having first poles and second poles that are attracted to each other so that the magnetic beads form a stacked arrangement.

25. The magnetic bead device of claim 21, wherein said at least one magnetic bead is greater than or equal to 55 mm in at least one direction.

26. The magnetic bead device of claim 21, wherein said at least one magnetic bead is greater than or equal to 33 mm in every direction.

27. A method of manufacturing a magnetic bead, the method comprising the steps of:
providing a magnetic bead;
positioning the magnetic bead in a coating chamber; and
depositing a metallic coating onto the magnetic bead in the coating chamber.
